(19) United States
(12) Patent Application Publication
(10) Pub. No.: US 2025/0029162 A1
(43) Pub. Date: Jan. 23, 2025

(54) SELF SERVICE ART VALIDATION TOOL

(71) Applicant: Leedsworld, Inc., New Kensington, PA (US)

(72) Inventors: Martin Olsina, Claremont (CA); Matthew Miller, Fort Lauderdale, FL (US)

(21) Appl. No.: 18/776,078

(22) Filed: Jul. 17, 2024

Related U.S. Application Data
(60) Provisional application No. 63/527,323, filed on Jul. 17, 2023.

(51) Int. Cl. G06Q 30/0601

(52) U.S. Cl. CPC G06Q 30/0621

(57) ABSTRACT

Presently disclosed is an online self-service validation of artwork/text for customization of a variety of products. The system provides real time guidelines for the parameters of the desired customization of the artwork/text on the chosen product and further provides real-time feedback regarding any issues for the uploaded artwork/text along with guidance of how to rectify the issues.

### RELATED APPLICATIONS

This disclosure claims priority to and benefit of U.S. Provisional Patent Application No. 63/527,323, entitled “Self Service Art Validation Tool,” filed on Jul. 17, 2023, the contents of which are incorporated herein by reference.

### TECHNICAL FIELD

The present disclosure relates to online product customization, and more specifically, to a system and method of validating uploaded artwork for customization upon a consumer product.

### BACKGROUND

Consumers increasingly seek to customize a wide variety of goods, from clothing to travel coffee mugs, with unique artwork or text. In the e-commerce age, many consumers conduct business through the internet from mobile devices and computers.

Presently, when a consumer uploads unique artwork or text for customizing a product, the company providing the customization utilizes a person to measure visually the placement of the artwork or text upon the product. Often the manufacturer first checks that the artwork or text will be of a proper size and quality for placement on the product that is being customized. Because companies often sell a variety of products, in order to make sure that the placement is correct, companies may utilize a guide to manually compare the art to the placement area of the product for size, quality and spacing. Manual comparison can be difficult, time consuming and is prone to human error. If there is a problem with the artwork sample, the consumer may then be notified of the problem to be corrected by the person analyzing the artwork. This can be time consuming and frustrating to all involved.

### SUMMARY OF THE DISCLOSURE

A system and method for a reliable online self-service validation of artwork/text for customization of a variety of products, through an e-commerce platform is disclosed. The system provides real time guidelines for the parameters of the desired customization of the artwork/text on the chosen product and further provides real-time feedback regarding issues for the uploaded artwork/text along with guidance of how to rectify the issues. The e-commerce platform disclosed and methods disclosed herein may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality described herein with respect to the present disclosure. Those skilled in the art should appreciate that such computer instructions can be written in a number of programming languages for use with many computer architectures or operating systems.

One exemplary embodiment is comprised of at least one server configured for implementation of the present disclosure. At the frontend, a server announcement including a user interface is presented to the customer in a web-based format that can be accessed by any remote device including but not limited to computers, tablets, and smart phones, or other technology as would be known to those of skill in the art. The user interface includes a plurality of parameters for the customer to select options related to a product, location, and decoration size. Additionally, there is an option for the customer to upload an art file.

Once the customer has selected the desired options and uploaded the art file, the frontend creates a load balancer object. In one embodiment, the frontend creates a JavaScript Object Notation (JSON) object. The JSON object includes the plurality of the selected parameters and the uploaded art file as data. The frontend sends the created JSON object internally to the backend for further processing of the order. The system is further constructed and arranged to read servers announcement state. The transmission can occur through an HTTP request or any other suitable communication method.

The backend receives the JSON object containing the customer's selected options and the uploaded art file. For example, the system reads the incoming JSON request relating to quantity. The backend calculates capacity and updates the load balancing object. The backend evaluates the information requirements specified in the JSON object. Next the files are locked, and the validation process starts. The system then reads the input JSON. The system then processes a request to perform a series of validations based upon the product, artwork, and imprinting method and then generates an output JSON. The system then clears the cache and purges the locked files. The customer can then chose to complete the transaction and stop communicating with the validation server or can initiate another order and request art/text validation.

The backend of the disclosed system is constructed and arranged to perform a series of validations, for example, using JavaScript, in an Adobe environment, to process and analyze the uploaded art file. In one embodiment, the backend validates and analyzes the art file based on predetermined requirements, for example including but not limited to quality, size, and spacing for the chosen product and imprinting method. For example, the system is configured to set boundaries and set point parameters. In one exemplary embodiment the system may employ vectors for measurement to confirm the placement of the artwork/text with the appropriate size and spacing for the chosen imprinting method upon the selected products. Uploaded artwork/text can be traced in vectors between nodes and each line and node are analyzed. After completing the validations and processing on each art file, the backend generates a response JSON object. The response JSON object includes the results of the validations and any additional information or recommendations based on the analysis.

The backend sends the response JSON object back to the frontend. This transmission can occur through an HTTP response, or another suitable communication method known to one of skill in the art. The frontend captures the response JSON object from the backend and formats the response data to present it in a user-friendly manner. The formatted response is then displayed to the customer through the frontend user interface. The display to the customer includes details such as validation results, analysis findings, recommendations, any other relevant information required to successfully place a customized product order.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing features may be more fully understood from the following description of the drawings. Various aspects of at least one embodiment are discussed below with reference to the accompanying figures, which are not necessarily drawn to scale, emphasis instead being placed upon illustrating the principles disclosed herein. The drawings aid in explaining and understanding the disclosed technology. Since it is often impractical or impossible to illustrate and describe every possible embodiment, the provided figures depict one or more exemplary embodiments. The figures are incorporated in and constitute a part of this specification but are not intended as a definition of the limits of any embodiment. Accordingly, the figures are not intended to limit the scope of the invention. Like numbers in the figures denote like elements. For purposes of clarity, not every component may be labeled in every figure.

FIG. 1 is a flowchart illustrating the process disclosed in one embodiment;

FIGS. 2A and 2B are representations of a screen display of a user interface according to one aspect of the present disclosure;

FIG. 3 is a representation of a screen display of a user interface for uploading artwork/text according to one aspect of the present disclosure;

FIG. 4 is a representation of a screen display generating a successful artwork validation according to one aspect of the present disclosure;

FIG. 5 is a representation of a screen display generating an unsuccessful artwork validation according to one aspect of the present disclosure;

FIG. 6 is a representation of a screen display of an administrator access to make changes according to one aspect of the present disclosure;

FIG. 7 is a representation of a screen display of an administrator access to make changes according to one aspect of the present disclosure;

FIG. 8 is a representation of a screen display of an administrator access to make changes according to one aspect of the present disclosure;

FIG. 9 is a representation of a screen display of an administrator access to make changes according to one aspect of the present disclosure;

FIG. 10 is a representation of a screen display of an administrator access to make changes according to one aspect of the present disclosure;

FIG. 11 is a representation of a screen display of an administrator access to make changes according to one aspect of the present disclosure;

FIG. 12 is a representation of a screen display of an administrator access to make changes according to one aspect of the present disclosure; and

FIG. 13 is a representation of a screen display of an administrator access to make changes according to one aspect of the present disclosure.

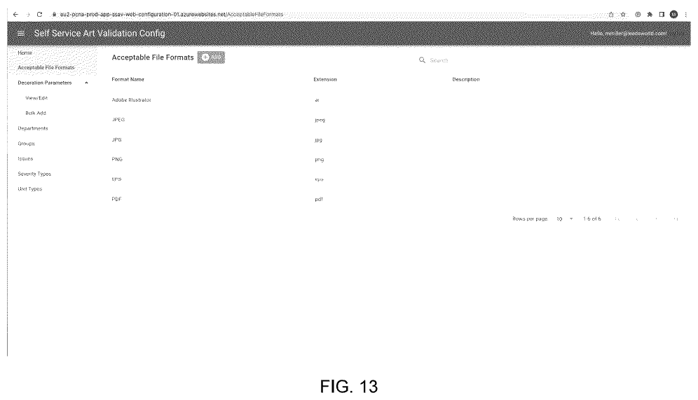

### DETAILED DESCRIPTION OF THE DISCLOSURE

The present disclosure will hereinafter be described with respect to one or more exemplary embodiments, with the understanding that the present disclosure is to be considered an exemplification and is not intended to limit the invention to the specific embodiments illustrated. It will be understood to one of skill in the art that the apparatus is capable of implementation in other embodiments and of being practiced or carried out in various ways. Also, the phraseology and terminology used herein is for the purpose of description and should not be regarded as limiting. Any references to examples, embodiments, components, elements or acts of the apparatus herein referred to in the singular may also embrace embodiments including a plurality, and any references in plural to any embodiment, component, element, or act herein may also embrace embodiments including only a singularity (or unitary structure). References in the singular or plural form are not intended to limit the presently disclosed apparatus, its components, acts, or elements. The use herein of “including,” “comprising,” “having,” “containing,” “involving,” and variations thereof is meant to encompass the items listed thereafter and equivalents thereof as well as additional items. The use of the term “artwork or art” refers to any upload for imprinting on a product and includes, but is not limited to, numerals, graphic, representation, text, and photographs, or any other personalization/customization. References to “or” may be construed as inclusive so that any terms described using “or” may indicate any of a single, more than one, and all of the described terms.

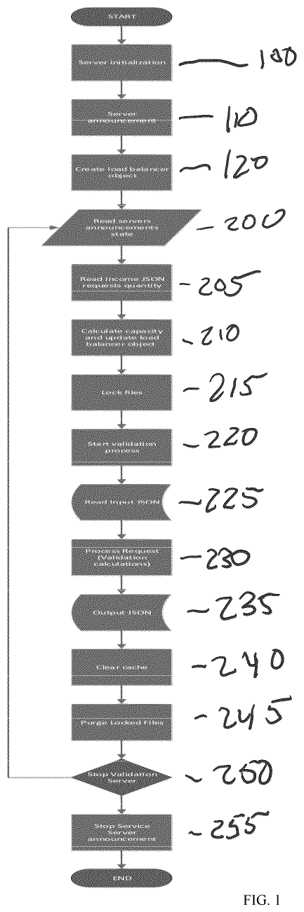

Referring initially to FIG. 1, disclosed is a flow chart representation of how the present disclosure can be implemented for customer interface. At least one server 110 is configured for implementation of the present disclosure. At the frontend, a server announcement 110 including a user interface is presented to the customer in a web based format that can be accessed by any remote device including but not limited to computers, tablets, and smart phones, or other devices as would be known to those of skill in the art. The user interface includes a plurality of parameters for the customer to select options related to a product, location and decoration size. Additionally, there is an option for the customer to upload an art file.

Once the customer has selected the desired options and uploaded the art file, the frontend creates a load balancer object 120. In one embodiment, the frontend creates a JavaScript Object Notation (JSON) object. The JSON object includes the plurality of the selected parameters and the uploaded art file as data. The frontend sends the created JSON object internally to the backend for further processing of the order. The system is constructed and arranged to read servers announcement state 200. The transmission can occur through an HTTP request or any other suitable communication method.

The backend receives the JSON object containing the customer's selected options and the uploaded art file. For example, the system reads the incoming JSON request relating to quantity 205. The backend calculates capacity and updates the load balancing object 120. The backend evaluates the information requirements specified in the JSON object. Next the files 210 are locked and the validation process 220 starts. The system then reads the input JSON 225. The system then processes a request 230 to perform a series of mathematical validations and generates an output JSON 235. The series of validations occurs at the backend of the system and includes, for example, validations based upon the selected product, artwork, and imprinting method for example, using JavaScript, in an Adobe environment, to process and analyze the uploaded art file.

In one embodiment, the backend utilizes various algorithms or techniques to validate and analyze the art file based on predetermined requirements. For example, the system is configured to set boundaries and set point parameters. The system may utilize vectors to perform measurements to validate the predetermined parameters of the artwork, for example size and spacing, for placement upon a particular product, based upon the product size, geometry, and material as an example. Uploaded art may be traced in vectors between nodes and analyzed for each line and node. After completing the validations and processing on each art file, the backend generates a response JSON object. The response JSON object includes the results of the validations and any additional information or recommendations based on the analysis.

The backend sends the response JSON object back to the frontend. This transmission can occur through an HTTP response, or another suitable communication method known to one of skill in the art. The frontend captures the response JSON object from the backend and formats the response data to present it in a user-friendly manner. The formatted response is then displayed to the customer through the frontend user interface. The display to the customer includes details such as validation results, analysis findings, recommendations, any other relevant information required to successfully place a customized product order. The system then clears the cache 240 and purges the locked files 245. The customer can then chose to complete the transaction and stop communicating with the validation server or can initiate another order and request art validation.

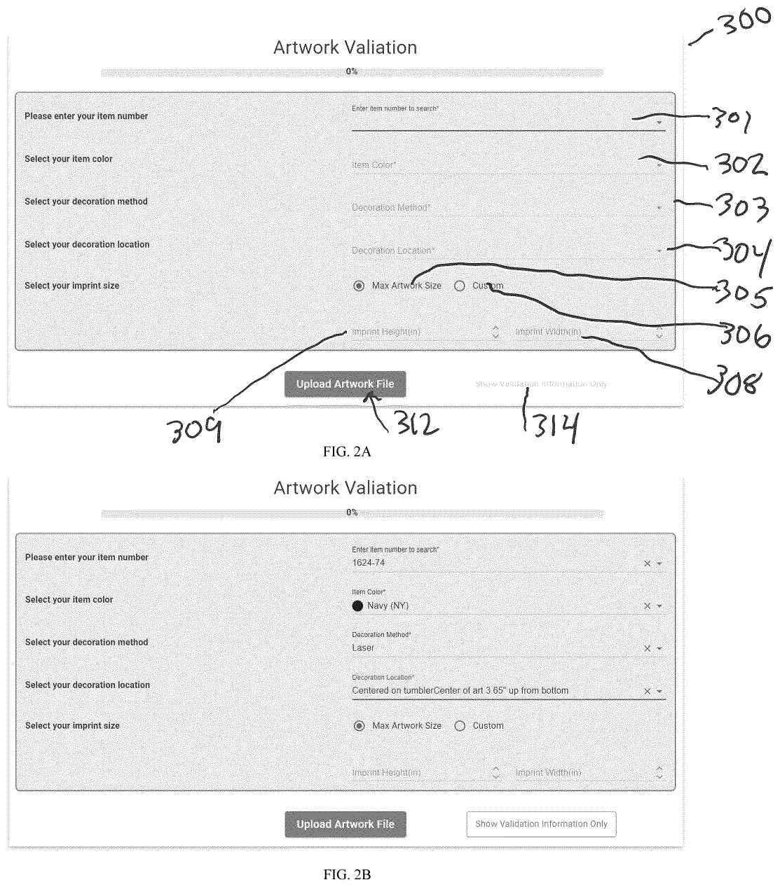

FIGS. 2A and 2B are an exemplary embodiment of the customer interface of the present disclosure for artwork validation 300. Products for sale are preloaded into a database and accessible by the customer through a listing that may be provided, for example, through a drop box 301, for a customer to select the items desired to be purchased. The customer can then select the item color in a color dropdown menu bar 302, the decoration or imprinting method in decoration dropdown menu bar 303 and the decoration/artwork location in a location dropdown menu bar 304. Each item for sale has its own identification number and corresponding options for a user to customize their order. The user then has to select the imprint size of the artwork. The user can opt to utilize the maximum artwork size by selecting button 305 or can opt for custom sizing by selecting button 306. If a user selects custom, a size may be entered in height at location 308 and a width at location 309 in the user interface. Only one parameter can be entered, depending on the information available at the time of the data input. For example, if a customer desires a logo that is 3 in wide, they would enter 3″ in interface location 309. Another feature of the user interface is the show validation information only button 314. The user can click on button 314 to see the decorating standards of the piece selected. Once the customer has inputted the desired parameters, they will click on the upload artwork file button 312.

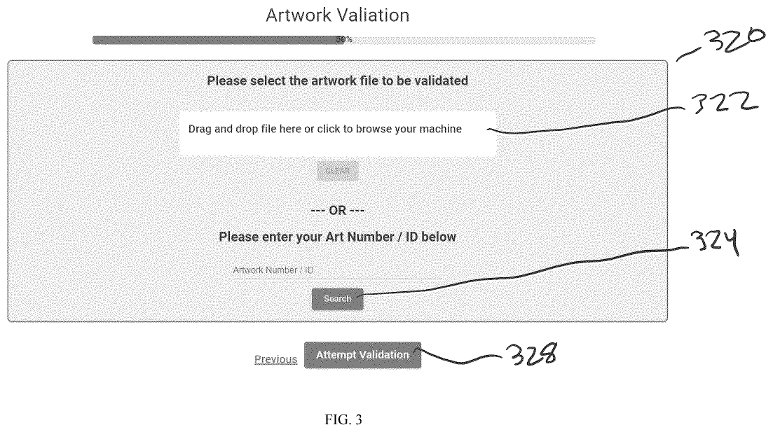

FIG. 3 is an exemplary embodiment of the user interface 320 for uploading artwork. The user may either drag and drop the artwork file into the box 322 or click in the box 322 to chose a file, find the file where it is located, click on it, and click open. Another option is to click search button 324 to search a library of preloaded artwork maintained in the host server. Once an artwork file is selected and attached, a user clicks the attempt validation button 328 to move to the next screen in the user interface.

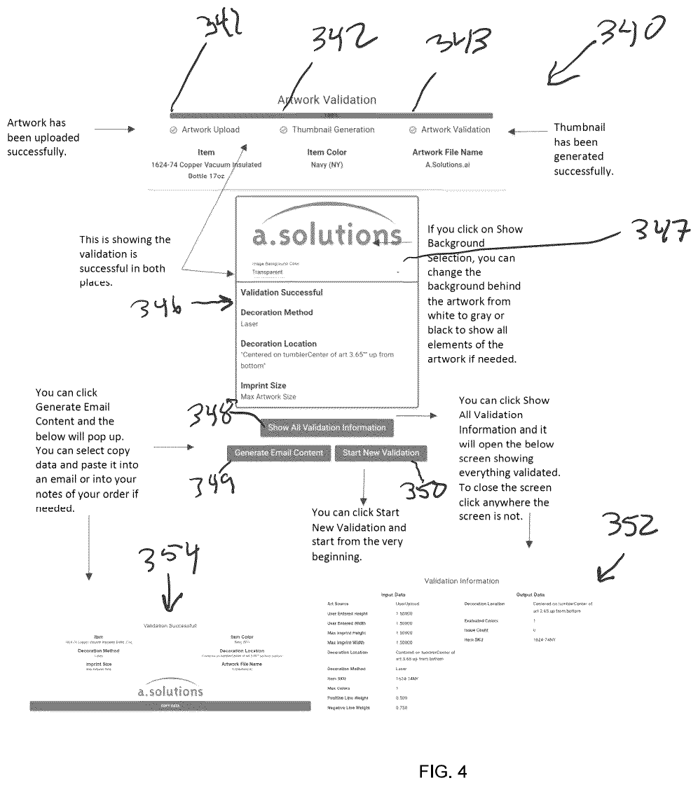

A successful validation will generate a user interface 340 as depicted in the exemplary embodiment of FIG. 4. The artwork will indicate a successful upload, for example through an indicator symbol 341 illuminated green. Thumbnail generation success may be indicated through an indicator symbol 342 that is green and an actual thumbnail example 346. Successful artwork validation may be indicated through an indicator symbol 343 that is green. If a user clicks on show background selection 347, a user can change the background behind the artwork from white to gray or black to show all elements of the artwork, as needed. A user can click on show all validation information button 348 and it will open the screen 352 showing the details of the successful validation. A generate email button content button 349 may also be included that when clicked on by the user will generate a pop up 354 with all the details of the successful art validation process for insertion into an email. After a successful validation, the user can complete the order or may click on start new validation button 350 to start a new artwork validation order from the beginning.

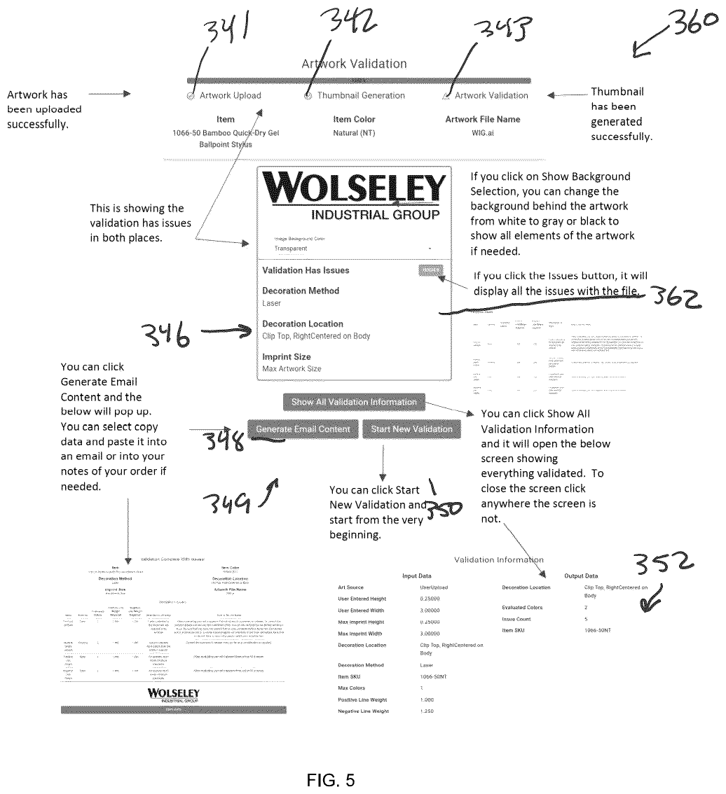

An unsuccessful validation will generate a user interface 360 as depicted in the exemplary embodiment of FIG. 5. The validation returns issues as either errors and/or warnings to the user for the identified problems. In this example, indicator symbol 341 may be green, indicating that the artwork uploaded and indicator symbol 342 may be illuminated green indicating that the thumbnail generation was successful. The actual thumbnail example 346 indicates that the validation has issues and generates an issues button 362. Indicator symbol 343 may be illuminated yellow indicating that the artwork validation has issues or warnings for the user. Clicking on the issues button 362 will display all identified issues with the file.

In the disclosure, non-limiting examples of issues are:
Fonts not created to outlines.
Vector artwork is required for the method.
If raster artwork is allowed for the method, is it meeting the DPI requirement of 300 dpi.
The components of the artwork are not meeting the positive line weight requirements.
The components of the artwork are not meeting the negative line weigh requirements.

In the disclosure, non-limiting examples of warnings are:
There are more colors in the artwork than are supported by the method selected.
The file contains transparency.
A color in the artwork is not supported by the method selected.
Gradients are present in the artwork and cannot be printed for the method selected.
White elements are present in the artwork. Should they print or be removed?

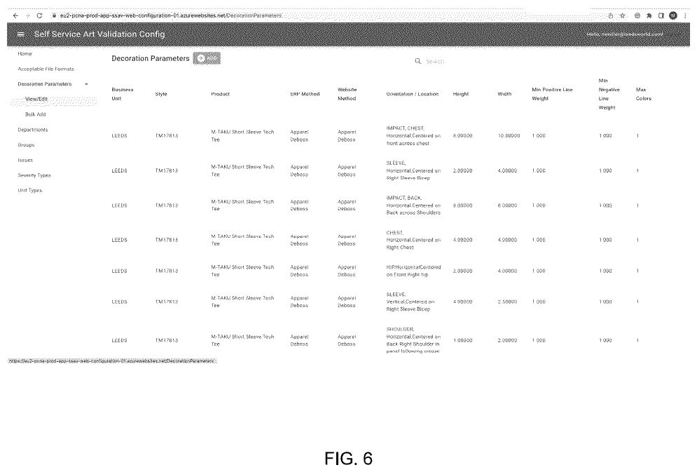

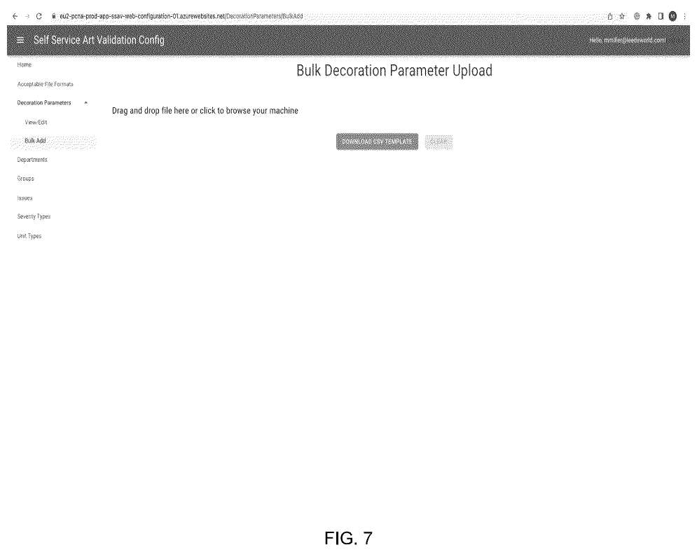

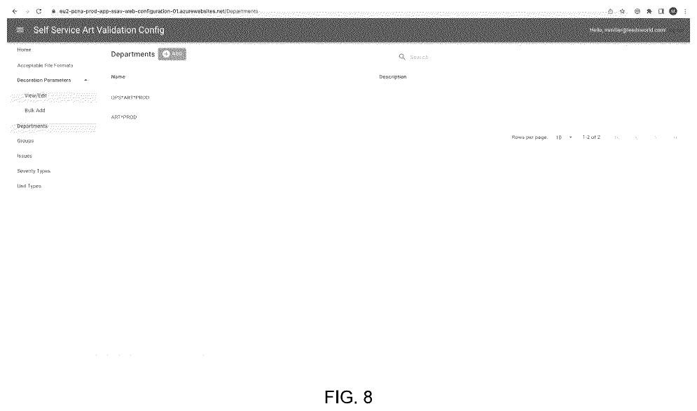

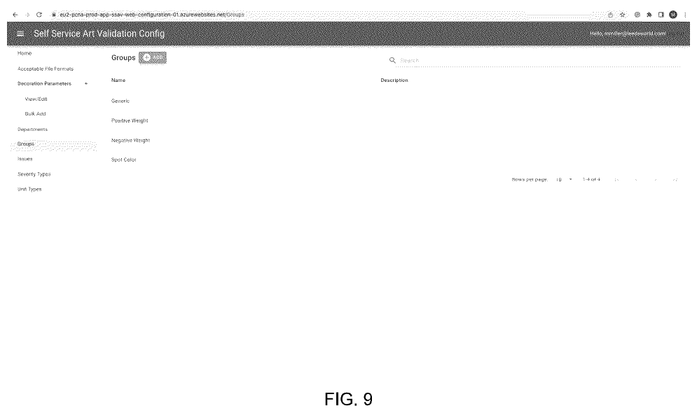

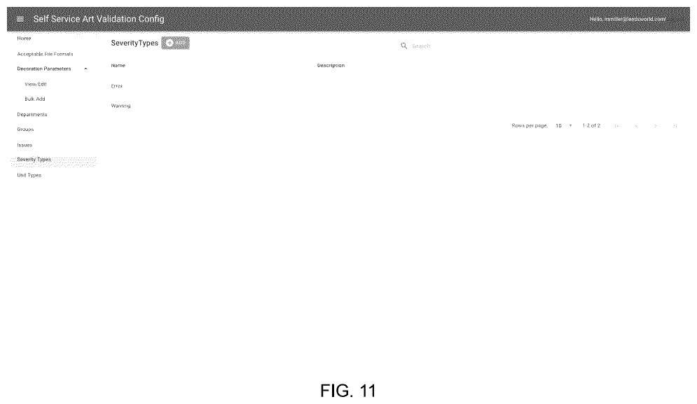

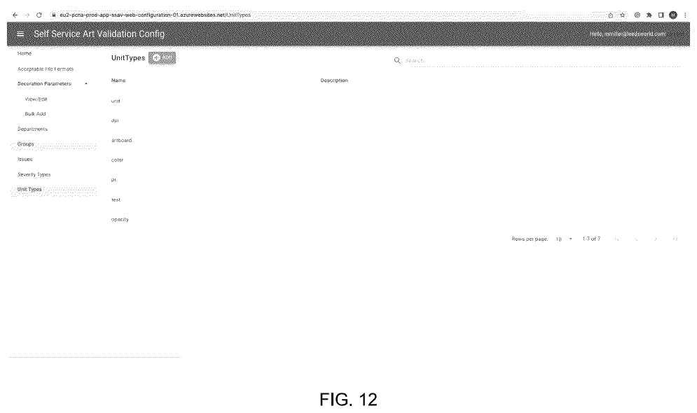

FIG. 6-12 are exemplary embodiments of administrator screens for making database changes to the self-service art validation configurations. An administrator can upload and maintain various data for facilitation of the art validation system. In a non-limiting example, the database is comprised of information that identifies the business unit that sells the product, the style and the product. Additionally, the database may contain information detailing the decorating options and the orientation/location of the artwork on a specific product. Parameters regarding predetermined heights and widths, minimum positive line weights and minimum negative line weights may also be included in the database. Also, the maximum number of colors available for each product may be maintained in the database.

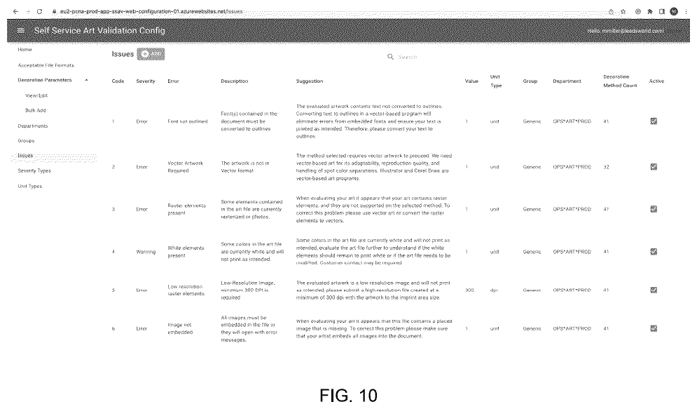

When artwork validation issues are generated, FIG. 10 is an exemplary embodiment of an administrator screen in which information related to issues is maintained. When artwork issues are detected, errors and warnings are generated to the user interface. The user will receive information describing the error and/or warning and information regarding how to fix the issue. One the issues are resolved, and validation is successful, the order can be completed and sent to production.

Having thus described several aspects of at least one disclosed example, it is to be appreciated that various alterations, modifications, and improvements will readily occur to those skilled in the art, without departing from the spirit and scope of the invention as defined by the appended claims. The systems, devices, and methods described above are example systems, devices, and methods shown for the purpose of understanding and illustration. Variations on these systems, devices, and methods are within the scope of the disclosure. Also, equivalent systems, devices, and methods are within the scope of the disclosure. Blocks of the block diagrams or flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions. Flowcharts illustrated in the figures and described in the disclosure do not necessarily require any particular order of the steps. Also, various steps may be added, removed, rearranged, and reordered as desired to produce the same or similar results and remain within the scope of this disclosure. Therefore, the claims are not to be limited to the specific example(s) depicted herein. For example, the features of one example disclosed above can be used with the features of other examples and do not limit the scope of the claims.

The computer program instructions and process disclosed herein may be stored in a computer-readable memory that can direct a computer or other programmable data processing apparatus to function in a particular manner. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks. The computer program instructions may also be stored on a carrier medium or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

Further, the purpose of the Abstract is to enable the U. S. Patent and Trademark Office, and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the claims of the application nor is intended to be limiting on the claims in any way.

What is claimed is:

1. A method for validating uploaded artwork for customization upon a consumer product that is accessible via an e-commerce platform user interface, comprising:
accessing by a remote device through a web-based format a user interface that communicates with at least one server having a front end and a backend,
selecting from a plurality of input parameters preprogramed on said user interface for customizing a product,
uploading an art file,
converting said plurality of input parameters and said uploaded artwork to data on said front end,
transmitting said data to said backend which is constructed and arranged to perform predetermined validations of said plurality of input parameters and creates a response object,
transmitting said response object back to said user interface for display of results, wherein a user is presented options for successfully placing a customized product order.

2. The method of claim 1, wherein said front end creates a JavaScript Object Notation (JSON) object that includes said plurality of input parameters and said uploaded art.

3. The method of claim 1, wherein said backend utilizes a series of computations and validations based on predetermine requirements, to analyze and validate said uploaded artwork based on predetermined requirements.

4. The method of claim 1, further comprising the step of tracing said uploaded artwork in vectors between nodes.

5. A system for validating uploaded artwork for customization upon a consumer product that is accessible via an e-commerce platform user interface, comprising:
at least one server constructed and arranged having a front end and back end in communication,
said at least one server having a user interface that includes a plurality of predetermined parameters, wherein a consumer can select parameters related to a product from a preloaded database and upload an artwork file,
said front end computes an object that includes said plurality of parameters and said artwork file as data,
said front end transmits said object to said backend for processing
wherein the processing includes performing a series of computations and validations based on predetermine requirements,
said backend end generates a response object for transmission to said front end, wherein said response object includes the results of validations and any additional information or recommendations based on said analysis to complete an order.

6. The system of claim 5, wherein said front end object created is a JavaScript Object Notation (JSON) object.

7. The system of claim 5, wherein said validations are calculated, using JavaScript, in an Adobe environment, to process and analyze said artwork file.

8. The system of claim 5, wherein the series of computations and validations includes computing set point parameters and boundaries by utilizing vectors to perform measurements to validate said artwork.

9. The system of claim 8, wherein the set point parameters include one of at least size and spacing of said artwork.

10. The system of claim 5, wherein the series of computations and validations includes analyzing a predetermined positive line weigh requirement and a negative line weight requirement.

11. The system of claim 5, wherein said at least one server said front end and said backend communicate in real time.
